(19) United States
(12) Patent Application Publication
(10) Pub. No.: US 2004/0019516 A1
(43) Pub. Date: Jan. 29, 2004

(54) Method for calculating the probability that an automobile will be sold by a future date

(76) Inventors: Gintaras Vincent Puskorius, Novi, MI (US); Irving Toivo Salmeen, Ann Arbor, MI (US); Lan Wang, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/202,659

(22) Filed: Jul. 24, 2002

(51) Int. Cl. G06F 17/60

(52) U.S. Cl. 705/10

(57) ABSTRACT

A method for calculating the probability that one or more automobiles will be sold by a future date includes performing a survival analysis based on historical days-on-lot data for one or more automobiles to generate a survival function. Based on the survival function, a probability that one or more automobiles will be sold by a future date is calculated. Days-on-lot data may include censored and geographic data. The survival analysis may additionally consider automobile content data and calculate sales impact values for various content items. The survival analysis may also consider incentive, automobile pricing, marketing and time-varying data. Data may be encoded into co-variate data for input into the survival analysis.

### BACKGROUND OF THE INVENTION

1. Field of the Invention

The present invention relates to a method for calculating the probability that an automobile will be sold by a future date.

2. Background Art

Automobile manufacturers and retailers are in a constant struggle to better understand what attributes of an automobile, incentive program, regional characteristics, etc., most affect vehicle sales. Often, the factors that affect vehicle sales interrelate. In addition, some factors may vary over time. These and other challenges make it difficult for automobile manufacturers and retailers to efficiently or most effectively tailor their products and sales techniques to the unique needs of their customers.

Many decisions that are made by a vehicle manufacturer or retailer ultimately affect the desirability of the manufactured vehicles. Offering the right vehicle configuration in the right mix at the right time and at the right price is a complicated problem. Decisions made early in the product development process could have a significant impact. For example, a poor match of powertrain with intended vehicle use could result in poor sales performance. On the other hand, vehicle days-on-lot can also be affected by changing cash and incentive programs during the course of a vehicle's model year. Other marketing actions, in the form of advertising or special offers, can also be used to enhance vehicle sales. Understanding the degree to which various factors, ranging from available vehicle configurations to the levels of incentives and inventories, ultimately enables a vehicle manufacturer to make better decisions with respect to its products and customers.

The present invention is a novel methodology for calculating the probability that an automobile will be sold by a future date.

### SUMMARY OF THE INVENTION

The present invention involves a novel application of survival analysis methods to determine how vehicle configurations impact the length of time that a vehicle resides in inventory.

In one embodiment of the present invention, multiple factors that affect vehicle days-on-lot are considered simultaneously in a statistical analysis. This embodiment may be advantageous because it tends to prevent incorrect inferences about the combined influence of multiple factors. For example, a simple univariate analysis of a particular vehicle's sales may suggest that vehicles without air conditioning sold at a slower rate than those with air conditioning, suggesting that the manufacturer should offer more of these vehicles with air conditioning. However, a proper statistical analysis, such as that described below may suggest that other factors, not air conditioning, were influencing the sales rate. Based on this information, a more reasonable manufacturing decision, for example, would be to offer air conditioning less frequently on certain types of vehicles.

Second, when performing days-on-lot analysis in real-time (i.e., looking at current model year data), we may observe a situation in which many vehicles have arrived at the dealerships, but have not yet been sold. For example, as of mid-May, 2001, nearly 50,000 out of 125,000 of a particular vehicle that had arrived at a set of dealerships had not yet been sold. The days-on-lot data for these vehicles are considered to be incomplete or “censored data” because we do not know the final days-on-lot for the 50,000 unsold vehicles but only a lower bound on their days-on-lot. Ignoring censored observations or treating these observations as sold vehicles can underestimate the actual days-on-lot for the entire collection of vehicles, giving the impression that vehicles are selling faster than they really are. One embodiment of the present invention considers censored data in the analysis.

One embodiment of the present invention involves using statistical methods known as survival analysis to model vehicle days-on-lot. Survival analysis is a group of statistical tools that analyze time to event or duration data.

For the purposes of modeling days-on-lot with survival analysis, one variable of interest is the duration for which a vehicle is in inventory. One advantage of applying survival analysis techniques to the vehicle days-on-lot analysis is that unsold vehicles (i.e., the censored observations) are treated consistently with those observations corresponding to actual sales. Furthermore, the analysis may be multivariate. This feature enables simultaneous modeling of the effects of various factors that could influence days-on-lot. The results obtained via survival analysis provide a more realistic view of what drives vehicle sales, including quantification of the degree to which the various factors affect a vehicle's days-on-lot performance. This aspect of the present invention is also advantageous because it enables more accurate what-if modeling (scenario analysis) to predict how days-on-lot is likely to change with changes in availability of vehicle and sales options. The present invention could be used to help determine how vehicles should be configured as well as their mix rates for some desired level of sales performance (e.g., a desired level of days-of-supply), and provides a basis for developing a model-year close-out strategy. A particularly novel application would be to employ the results of survival analysis to guide changes in various incentive programs to affect vehicle sales rates.

The present invention is particularly advantageous to the automotive marketing field. There are many relevant marketing inquiries for which the present invention can provide insight. These inquiries include, but are not limited to:

How do inventory levels, both for the vehicle in question, as well as for competing vehicles, affect days-on-lot?

What effect do carry-over vehicles have on the days-on-lot performance of new model year vehicles, and vice-versa?

Are there regular patterns of seasonality impacting days-on-lot?

How does advertising, both our own and competitive, affect days-on-lot? How do competitors' incentive programs affect our days-on-lot?

How do measures of consumer confidence, as well as other economic indicators, affect days-on-lot?

Do fluctuations in residual values affect days-on-lot? How do announcements of vehicle recalls, other bad and good news, impact days-on-lot?

How do bundles of features impact days-on-lot?

How do transaction prices and days-on-lot interact?

What information can analysis at a more geographically specific level offer? When the number of observation is sufficiently large, analysis can be done at more geographically specific levels, e.g., regional level, zone level.

How do other duration data affect vehicle sales? Extensions of our analysis can be made to analyze related duration data and address supply chain questions.

One embodiment of the present invention is a method for calculating a probability that one or more automobiles will be sold by a future date. This embodiment includes performing a survival analysis based on historical days-on-lot data for one or more automobiles to generate a survival function and calculating a probability that one or more automobiles will be sold by a future date based on the survival function. The days-on-lot data may include an indication as to whether automobiles have been sold. The days-on-lot data may also include geographic information.

The survival analysis may also consider automobile content data. In this arrangement, the methodology may additionally include identifying a baseline content configuration, and calculating a sales impact value for one or more automobile content items. The impact value for one or more of the content items may be relative to the baseline content configuration.

The survival analysis may also consider incentive or automobile pricing data. The incentive or automobile pricing data may include competitor incentive or automobile pricing data. The survival analysis may consider time-varying event data or marketing data.

This embodiment may additionally include encoding data to be input to the survival analysis into co-variate data, and performing the survival analysis on the co-variate data. A tail distribution may be calculated for the survival function. Co-dependent data may be excluded from the survival analysis.

Another embodiment of the present invention is a method for estimating vehicle days-on-lot performance. This method may include a data processing step for converting vehicle data and order guide data into coded data, a statistical processing step for generating model parameters a baseline model based on the coded data, and a survival analysis step for estimating vehicle days-on-lot performance. This embodiment may additionally include estimating the effectiveness of a vehicle incentive program. This embodiment may additionally include defining a sales distribution based on the survival analysis.

The above objects and other objects, features, and advantages of the present invention are readily apparent from the following detailed description of the best mode for carrying out the invention when taken in connection with the accompanying drawings and claims.

### BRIEF DESCRIPTION OF THE DRAWINGS

FIG. 1 is a chart illustrating a hypothetical view of change in vehicle retail inventory over time;

FIG. 2 is a chart illustrating a hypothetical survival curve estimated with the product-limit estimator;

FIG. 3 is a chart comparing hypothetical survival curves in which censored vehicles are treated as sold (g₁(t)) and in which censored vehicles are completely ignored (g₂(t));

FIG. 4 is a chart illustrating a hazard rate function for days-on-lot for a hypothetical vehicle;

FIG. 5 is a chart illustrating a comparison of hypothetical survival curves for two different regions;

FIG. 6 is a block flow diagram illustrating a preferred methodology for implementing one embodiment of the present invention; and

FIG. 7 is a block flow diagram illustrating an alternative methodology for implementing the present invention.

### DETAILED DESCRIPTION OF THE PREFERRED EMBODIMENTS

### Days-On-Lot Calculation

A days-on-lot value provides a quantitative indication of how well automobiles are selling from dealer incentives. In one embodiment of the present invention, this duration consists of two components (T, δ), where, if the vehicle is sold, T is the number of calendar days between the vehicle's arrival date at a dealership and its sales date, where the original and selling dealers may not be the same; if the vehicle is not sold, T is the number of calendar days between the vehicle's arrival date and observation date. The indicator δ indicates whether the vehicle is sold or not.

### Survival Analysis

The following detailed description of survival analysis concepts and techniques provides preferred statistical analysis techniques. Those of ordinary skill in the art will recognize, however, that a multitude of mathematical concepts and expressions, or variations thereof, may be implemented within the scope of the present invention.

The analysis of “time-to-event” data has applications to diverse fields, such as medicine, biology, public health, epidemiology, engineering, economics, and demography. What is referred to as “survival analysis” below may be similar to, substituted by, or referred to by a variety of statistical techniques such as duration data analysis, methods for lifetime data, methods for reliability data, analysis of failure time data, etc.

One embodiment of the present invention involves analyzing data and adjusting a survival function to account for concomitant information (sometimes referred to as covariates, explanatory variables or independent variables).

Survival analysis deals with the modeling and analysis of data that measures the amount of time that elapses until a particular event occurs. Examples include measurements of time to failure for industrial components (e.g., tires) or measurements of the time between onset of a particular disease and death from that disease. The time to event is usually described as the subject's failure time. The problem of analyzing duration data arises in a number of applied fields, such as medicine, biology, public health, epidemiology, engineering, economics, and demography. Survival analysis is typically performed to study how measured properties have affected existing subjects' survival time, and can be used to predict the survival time for new subjects.

One characteristic of time to event or duration data is the presence of censored or truncated observations. Censored data may arise when the actual event of interest is not known to have occurred or if the actual beginning or end of a temporal interval is unknown. One censoring mechanism encountered is right censoring, where all that is known is that a subject has not failed by a certain time. For example, some subjects may not have failed when a study is terminated. The time at which a subject ceases to be observed for some reason other than failure is called the subject's censoring time. All that can be inferred about the failure time of a censored subject is that it is greater than its censoring time. In the case of current model-year vehicle sales, any vehicle in current inventory may correspond to a right-censored observation.

One embodiment of the present invention involves employing a probabilistic approach to the modeling of survivability, using the principles of maximum likelihood estimation for parameter fitting purposes. Let T be a nonnegative random variable representing the time until some specified event. The cumulative distribution of survival time may be expressed as:

F(t)=Pr(T≦t) (1)

which gives the proportion of subjects expected to fail in less than or equal to t units of time. The survival function, which is the probability of an individual surviving beyond time t, may be expressed as:

S(t)=Pr(T>t)=1−F(t) (2)

Note that the survival function is a nonincreasing function with values of 1 at the origin and 0 at infinity. The probability density function f(t), may be expressed as:

$$f ( t ) = {lim}_{Δ t -> 0 +} \frac{F ( t + Δ t ) - F ( t )}{Δ t} \qquad ( 3 )$$

The survival function can be related to the probability density function by:

$$S ( t ) = 1 - {\int }_{0}^{t} f ( u ) ⅆ u = {\int }_{t}^{∞} f ( u ) ⅆ u \qquad ( 4 )$$

Another concept related to life distributions is the hazard rate function h(t). It specifies the instantaneous rate of failure at time t, given that the individual survives up until t, as may be expressed by:

$$h ( t ) = {lim}_{Δ t -> 0 +} \frac{Pr ( t \leq T < t + Δ t \vert T \geq t )}{Δ t} = \frac{f ( t )}{S ( t )} \qquad ( 5 )$$

Given this relationship between the hazard, survival and probability density functions, and using the fact that

$$f ( t ) = - \frac{ⅆ}{ⅆ t} S ( t ) ,$$

then we can write:

$$h ( t ) = - \frac{\frac{ⅆ}{ⅆ t} S ( t )}{S ( t )} = - \frac{ⅆ}{ⅆ t} ln ( S ( t ) ) \qquad ( 6 )$$

Thus, the survival function may be expressed in terms of the hazard function by:

$$S ( t ) = {ⅇ}^{- {\int }_{0}^{t} h ( u ) ⅆ u} = {ⅇ}^{- H ( t )} \qquad ( 7 )$$

where the term

$$H ( t ) = {\int }_{0}^{t} h ( u ) ⅆ u \qquad ( 8 )$$

is known as the cumulative hazard function.

The term hazard may describe the concept of risk of failure in the interval just after time t, conditional on the subject having survived up until this time. If the hazard function is a constant (i.e., it does not depend on time), one interpretation may be that the probability that the subject fails in the next time interval does not depend on how long it has survived. Thus, for a constant value of h(t)=0.1, the interpretation may be that the subject has a 10% chance of failing in the next time interval, independent of how long it has already survived.

Empirical estimators of the survival function including the Kaplan-Meier or Product-Limit estimator incorporate information from available observations, including those that are censored. Assume we have a sample of n independent observations, and that the survival times are rank-ordered as t₁<t₂< . . . <t_{D}, where t_{D} is the last recorded time. Then, the number of subjects at risk of failing at time tᵢ is given by nᵢ, while the number actually observed to have failed at time tᵢ is given by dᵢ(note that censored observations can never be counted as having failed). The product-limit estimator of the survival function at time t may be expressed as:

$$\hat{S} ( t ) = {\prod }_{t , \leq t} \frac{{n}_{t} - {d}_{i}}{{n}_{i}} \qquad ( 9 )$$

with the convention that Ŝ(t)=1 if t<t₁.

When a population is heterogeneous, a finite number of homogeneous subpopulations may be characterized and distinguished by a set of explanatory variables (often referred to as covariates in the survival analysis literature). In the case of the sale of vehicles, we may observe that the sales rate and days-on-lot performance are correlated with vehicle options. If the number of possible features is small (e.g., all vehicles are alike except for only two possible exterior colors), then we could develop separate survival functions with the product-limit estimator and compare them directly. On the other hand, as the number of explanatory variables increase, the ability to meaningfully employ this form of non-parametric estimation may be reduced.

There are several parametric models which allow us to quantify the relationship between time-to-event T (days on lot) and a set of explanatory variables (also called covariates) Z=(Z₁, Z₂, . . . Zₚ).

We now consider one class of models that are applicable to the days-on-lot problem—the Cox proportional hazards model. The hazard function takes the following form:

h(t,Z,β)=h₀(t)e^{β}^{^{T}}^{Z} (10)

where β is the parameter vector for Z, β^{T}Z=β₁Z₁+β₂Z₂+ . . . +βₚZₚ, and h₀(t) is the hazard function of the subpopulation, called the baseline population, for which the covariate vector Z=0. In applications of the model, h₀(t) may have a specified parametric form, or it may be any unspecified nonnegative function. The factor e^{β}^{^{T}}^{Z} adjusts h₀(t) up or down proportionately to reflect the effects of the measured covariates. The cumulative hazard function may be expressed by:

$$H ( t , Z , β ) = {\int }_{0}^{t} h ( u , Z , β ) ⅆ u \\ = {H}_{0} ( t ) {ⅇ}^{{β}^{T} Z} \qquad ( 11 )$$

The corresponding survival function may be represented as:

S(t,Z,β)=e^{-H}^{₀}^{(t)exp(β}^{^{T}}^{Z)} (12)

which, after simplification, yields the survival function

$$S ( t , Z , β ) = {[ {S}_{0} ( t ) ]}^{exp ( {β}^{T} Z )} \qquad ( 13 )$$

where the baseline survival function is given by S₀(t)=e^{-H}^{₀}^{(t)}.

Thus, we observe that the proportional hazards model also captures two characteristics of interest: the baseline survival function S₀(t) provides a nonparametric representation of the underlying structure of the survival time, while the exponential function of the covariates provides the systematic component.

Given some parametric or semi-parametric model for the distribution of survival times, the step of modeling duration data includes fitting the parameters of the specified model using all available data, preferably including those that correspond to censored observations. The method of Maximum Likelihood Estimation (MLE) may be employed as it provides a framework for handling censored observations.

### Application of Survival Analysis to Vehicle Sales Analysis

A. Covariate Data

Covariate data used in accordance with the present invention may be vehicle specific, e.g., options on vehicles (air conditioning, exterior color, engine type). The covariates could also be factors that are not vehicle specific, e.g., incentives, consumer price index, competitor's incentives, catastrophic events. Some covariates are static, while others are time-dependent.

Data for use in accordance with the present invention may include vehicle information, option content, financial and customer information, wholesale pricing information, production information, powertrain information, body style, interior/exterior colors, region of sale, lease information, final sales information, order, build, shipping, arrival and sales dates. Additional data that may be included in the analysis includes general economic conditions, competitor pricing and incentive data, and catastrophic event data (e.g., 9/11/01, vehicle recalls, etc.).

B. Preprocessing

A number of steps may be implemented to preprocess input data to produce a covariate data set that is more suitable for further analysis. These steps may be computer-implemented. In one embodiment of the present invention, a record of days-on-lot, a censoring indicator, vehicle content, and potentially arrival date information (for the case when the time-varying covariates are later introduced) are extracted and encoded. The days-on-lot is given directly, and censoring is indicated when there is no recorded sales date.

Vehicle content and options may be transformed from an ASCII representation to a numerical representation. For example, assume that in the case of a hypothetical vehicle, there are four possible values for the body style variable. One of the body styles may be selected as the base body style, and the remaining three body styles are represented with a sparse binary encoding, as in Table 1:

TABLE 1

| | | | |
|---|---|---|---|
| Body Style A | 0 | 0 | 0 |
| Body Style B | 1 | 0 | 0 |
| Body Style C | 0 | 1 | 0 |
| Body Style D | 0 | 0 | 1 |

In Table 1, three new binary vehicle body styles are identified, where a value of one for any of these variables indicates the presence of that body style, and where values of zero for all three indicates the presence of the default body style. In general, for a variable with m distinct levels, one employs a sparse binary encoding of m−1 binary variables. Choice of the base value is arbitrary, but should be guided by frequency of occurrence or by what is considered to be an option or a base feature.

Interdependencies may exist in the data. Some interdependencies may be easier to infer than others. For example, the specification of an engine for a vehicle such as Engine 1 or Engine 2 may completely specify the transmission type: standard or automatic. On the other hand, other vehicle features may have more complicated dependencies. For example, the presence or absence of fog lamps can be completely determined by vehicle trim level options. These dependencies can be almost entirely inferred through careful study of the vehicle's order guide. Variables which correspond to secondary features may be eliminated (e.g., the presence of fog lamps would be less important than the trim type or a special package).

An example of a hypothetical base vehicle is described in Table 2. The baseline may be chosen as that configuration which occurs with greatest frequency in the entire data set (independent of region). Alternatively, a different baseline may be chosen for each region. In the following illustrations, the baseline choice is maintained for all levels of analysis. And in the national analysis, the base region is RO.

TABLE 2
Hypothetical Baseline Vehicle Configuration

| CO-VARIATE | BASELINE FEATURE |
|---|---|
| Axle | Axle 1 |
| Body Style | Body Style A |
| CD Changer | CD Changer (6 Disc) |
| Engine | Engine 1 |
| Engine Block Heater | No |
| Entertainment System | No |
| Heated Seats | No |
| Moon roof | No |
| Outside Mirror | Black Power Mirrors |
| Paint (Exterior) | Exterior Paint 1 |
| Reverse Parking Aid | No |
| Seat Configuration | No |
| Skid Plates | No |
| Suspension | Regular |
| Tires | Tire 1 |
| Trail Tow Package | No |
| Trim Color | Trim Color 1 |
| Trim Type | Trim Type 1 |
| Comfort/Convenient Group | Comfort/Convenient Group |
| Off-Road Package | No |
| Sport Package | No |

C. Non-Parametric Analysis

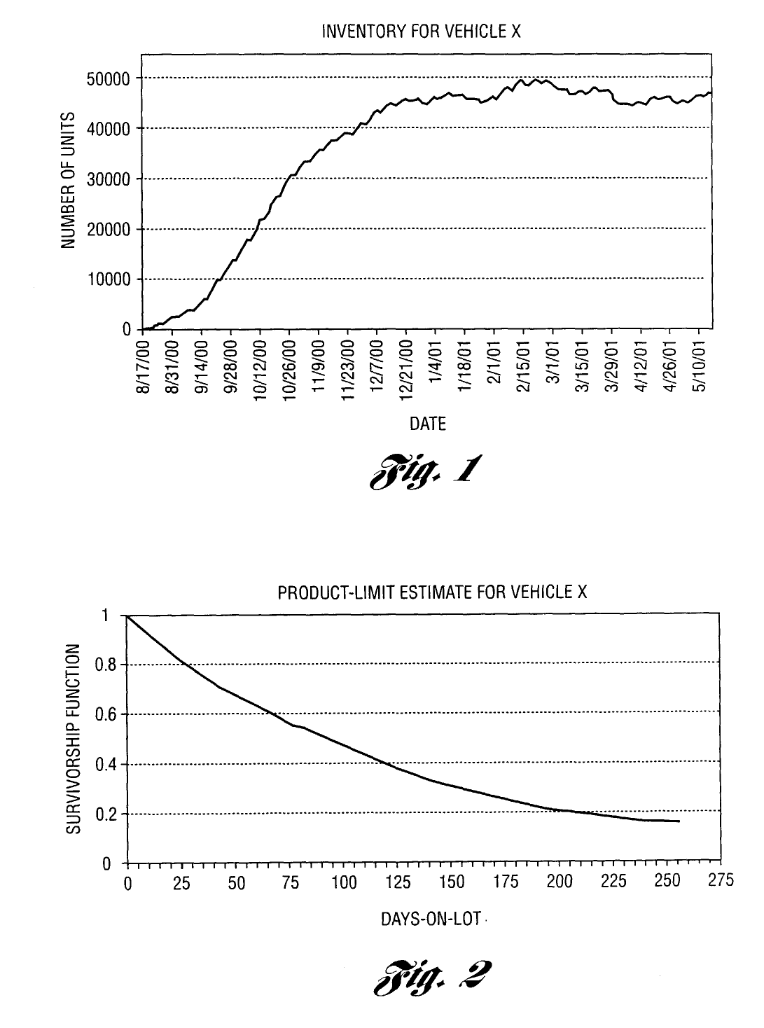

A product-limit estimator may be applied as described above to the entire set of assembled data to develop a view of average sales performance, irrespective of vehicle content. FIG. 1 provides a hypothetical view of the change in retail inventory for Vehicle X over time.

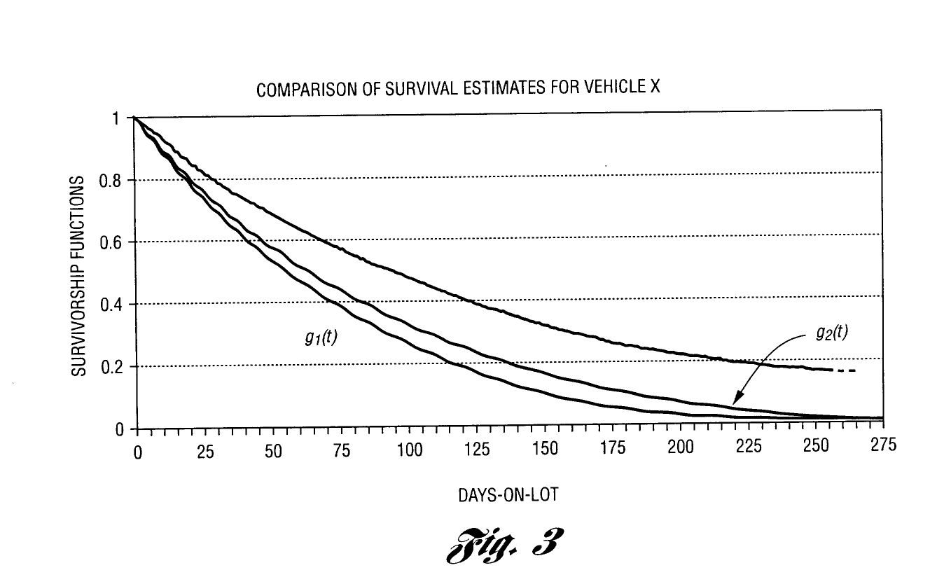

FIG. 2 shows an estimated product-limit survival curve for the Vehicle X example. Each point on the curve provides an estimate of the probability that any given vehicle will not be sold within a given number of days. Alternatively, we can also interpret this curve as providing an estimate of the fraction of vehicles that will not have been sold within a given number of days. For example, for t=100 days, one observes that the survival function evaluates to Ŝ (100)=0.5, which implies that roughly half of all vehicles are expected to require greater than 100 days to sell.

To illustrate the effect of not considering censored observations, two additional calculations are performed. In the first case, the censoring indicator is ignored, and all recorded days-on-lot, including those for censored observations, are treated as sold. In this case:

$${g}_{1} ( t ) = \frac{\# of vehicles with days \text{-} on \text{-} lot \geq t}{\# of vehicles} \qquad ( 14 )$$

gives an indication of the proportion of all vehicles with recorded days-on-lot of greater than t days, regardless of whether or not the vehicle has been sold. In the second case, all censored observations are ignored. The ratio

$${g}_{2} ( t ) = \frac{\# of sold vehicles with days \text{-} on \text{-} lot \geq t}{\# of all sold vehicles} \qquad ( 15 )$$

is an expression of the proportion of all vehicles that have been recorded as having been sold with survival times of greater than t days. g₂(t) may be computed for each point in time. The results of these calculations are plotted in FIG. 3 with the survival curve as computed by the product-limit estimator.

It is noteworthy that the curves corresponding to both g₁(t) and g₂(t) decrease at a substantially greater rate than the survival curve with censored data accounted for. Use of the alternatives in practice could result in an underestimate or overly optimistic view of the distribution of survival times especially in the presence of heavy censoring.

It is also possible to develop separate survival curves for subclasses of vehicles; for example, one could consider the survival curves for vehicles with 4×2 vs. 4×4 drivelines. Alternatively, one could consider the relative effect on days-on-lot of two or more different vehicle series.

D. Semi-Parametric Analysis

A semi-parametric framework provides one method by which to simultaneously infer the relative effects of different co-variants on the days-on-lot. This framework effectively scales to increased numbers and levels of categorical co-variants. The proportional hazards framework allows one to estimate the systematic effects for co-variants as well as a baseline survival function. Combining these two parts of the analysis enables one to assess the relative impact of features on sales rates as well as to predict average and/or median survival times for specific vehicle configurations.

The results of three different applications of the Cox proportional hazards framework will now be described. A model is developed that provides an overview of the performance of different vehicle features on a national level. This is followed with the development of a series of unique models at the regional level. In the case of a hypothetical vehicle such as Vehicle X, one might expect different customer preferences for different features and options in different sales regions. For example, it may be observed that nearly all Vehicle Xs (>>99%) sold in Region 1 are equipped with 4×4 drivelines, while less than 10% of Vehicle Xs ordered in Region O are equipped with 4×4 drivelines. Similarly, one might expect that customer preferences for colors will differ by region (darker and lighter colors in the northern and southern regions, respectively).

The proportional hazards framework may be applied to a special case of time-varying co-variants in which certain vehicle options are used as marketing incentives. In this case, the desirability of a vehicle can likely change when the incentive program is put into place, thereby changing the vehicles survival characteristics.

A statistical procedure such as PHREG may be employed with commercially-available software such as the SAS Statistics Software package. A stepwise regression method of backward elimination may be used to develop models that include parameter estimates found to be statistically significant.

Outputs of this statistical analysis may include two sets of values. First, a set of statistically significant parameter values may be obtained, as well as an indication of the level of significance, for a parameter vector β. A second set of values may be obtained for each point in time for which there is a survival-time and estimate of the baseline survival function as well as confidence limits for each of these points. The combination of these estimated values, coupled with the frequency of occurrence and co-occurrence of vehicle features and options, forms a basis for an interpretation of the results.

E. National Model

This model may be used to develop an assessment of the overall importance of different vehicle features on the rate at which vehicles sell. Example results for the systematic portion of the model are provided in Table 3.

TABLE 3
National Model for Vehicle X Sales

| | PAR. | | | PAR. | |
|---|---|---|---|---|---|
| CO-VARIATE | VALUE | FREQ | CO-VARIATE | VALUE | FREE |
| Axle 2 | −0.052 | 0.039 | Axle 3 | | 0.504 |
| Axle 4 | −0.094 | 0.043 | Axle 5 | −0.164 | 0.036 |
| Body Style B | −0.513 | 0.222 | Body Style D | 0.097 | 0.194 |
| Body Style C | −0.414 | 0.186 | W/O CD Changer | | 0.194 |
| Engine 2 | −0.407 | 0.591 | Eng Blk Heater | −0.124 | 0.018 |
| Rear Ent Sys | 0.663 | 0.108 | Heated Seats | | 0.160 |
| Moon roof | 0.345 | 0.262 | Rev Sensing | −0.049 | 0.152 |
| 2nd Row Capts | −0.144 | 0.101 | Skid Plate | 0.050 | 0.222 |
| 4-Corner Load Level | −0.273 | 0.063 | Rear Load Level | −0.214 | 0.149 |
| Tire 2 | −0.281 | 0.287 | Trailer Tow | −0.061 | 0.499 |
| Trim Color 2 | | 0.151 | Trim Color 3 | −0.079 | 0.273 |
| Trim Type 2 | −0.099 | 0.603 | Driv Trim Type 4 | −0.186 | 0.043 |
| Trim Type 3 | −0.198 | 0.107 | W/O Comf/Conv Grp | 0.076 | 0.027 |
| Off-Road Package | 0.529 | 0.028 | Sport App Pkg | 0.093 | 0.190 |
| Exterior Paint 2 | 0.127 | 0.182 | Exterior Paint 3 | −0.261 | 0.033 |
| Exterior Paint 4 | −0.165 | 0.074 | Exterior Paint 5 | | 0.024 |
| Exterior Paint 6 | −0.098 | 0.107 | Exterior Paint 7 | −0.137 | 0.093 |
| Exterior Paint 8 | −0.036 | 0.108 | Exterior Paint 9 | −0.236 | 0.192 |
| Exterior Paint 10 | | 0.098 | | | |
| Region 1 | 0.172 | 0.016 | Region 2 | 0.148 | 0.053 |
| Region 3 | | 0.018 | Region 4 | −0.156 | 0.127 |
| Region 5 | −0.234 | 0.063 | Region 6 | | 0.104 |
| Region 7 | −0.102 | 0.031 | Region 8 | 0.169 | 0.037 |
| Region 9 | −0.235 | 0.019 | Region 10 | | 0.020 |
| Region 11 | 0.379 | 0.033 | Region 12 | 0.122 | 0.025 |
| Region 13 | 0.114 | 0.054 | Region 14 | 0.347 | 0.014 |
| Region 15 | 0.179 | 0.189 | Region 16 | | 0.017 |

Note: The first and fourth columns may be assigned variable names indicating either the presence/absence of a feature/option or a sales region. The second and fifth columns contain parameter estimates that may be obtained via the SAS PHREG procedure. The third and sixth columns contain frequency of occurrence of the feature/option or region.

Interpretation of the parameter estimates for a proportional hazards model may vary from the interpretation for a linear regression model. Consider the variable denoted by Rear Ent Sys with a parameter value of 0.663. Further assume that there are two identical vehicles with the exception that the first comes without a rear entertainment system, whereas the second vehicle has this option. Assume that the first and second vehicles' co-variate vectors are encoded by Z₁ and Z₂, respectively. With the proportional hazards model, the ratio of the hazard functions for these two vehicles is independent of the baseline hazard function and only depends on the systematic part of the model, which may be expressed as:

$$H R ( t , {Z}_{1} , {Z}_{2} ) = \frac{h ( t , {Z}_{2} , β )}{h ( t , {Z}_{1} , β )} \qquad ( 16 )$$

An evaluation of this equation for our hypothetical situation may be expressed as:

HR(t,Z₁,Z₂)=e^{0 663} (17)

This result may be considered to be a relative risk ratio, i.e., that vehicles with rear seat entertainment systems are at nearly twice the “risk” of selling, by e^{0.663}≈2, at any given point in time, as those vehicles without these systems.

There are a number of conclusions that one may make after careful consideration of these experimental results. First, there are a number of features that appear to be popular, particularly the moon roof and the rear entertainment system. This suggests that there are opportunities to either increase the mix rates of these preferred options, or alternatively, to potentially increase the prices charged. In either case, it is likely that these actions would result in the decrease of the relative rate-of-sale; but, if executed properly, the decrease in the rate-of-sale would be offset by higher overall revenue and profit. On the other hand, it is observed that there are a number of features, some of which are considered to be premium options, such as the Engine 2, that appear to sell substantially more slowly than our chosen baseline. Furthermore, this national analysis also suggests that Body Style B and Body Style C sell more slowly than Body Style A. Finally, it is noteworthy that Exterior Paint 9, which is used on nearly 20% of all vehicles, sells more slowly than most of the other exterior paint colors. Although Exterior Paint 9 is considered to be a popular color, it is likely that this color is ordered much too frequently, resulting in an over-supply of vehicles with this exterior paint color.

One may wish to consider relative co-occurrences of features with one another and within certain regions. For example, Region 1 has a positive region parameter value, meaning that the baseline vehicles appears to sell on average faster in Region 1 than in the baseline region (Region O). However, it has been noted that the number of Body Style A and Body Style D vehicles sold in Region 1 is negligible. Thus, one interpretation would be to take the positive parameter value associated with Region 1, and view it as an offset for either of the two negative-valued parameters associated with the Body Style B and Body Style C vehicles. With this adjustment, it could then be concluded that the baseline vehicle with Body Style A actually sells faster in Region O than the same baseline vehicle, but with Body Style B or Body Style C, sells in Region 1.

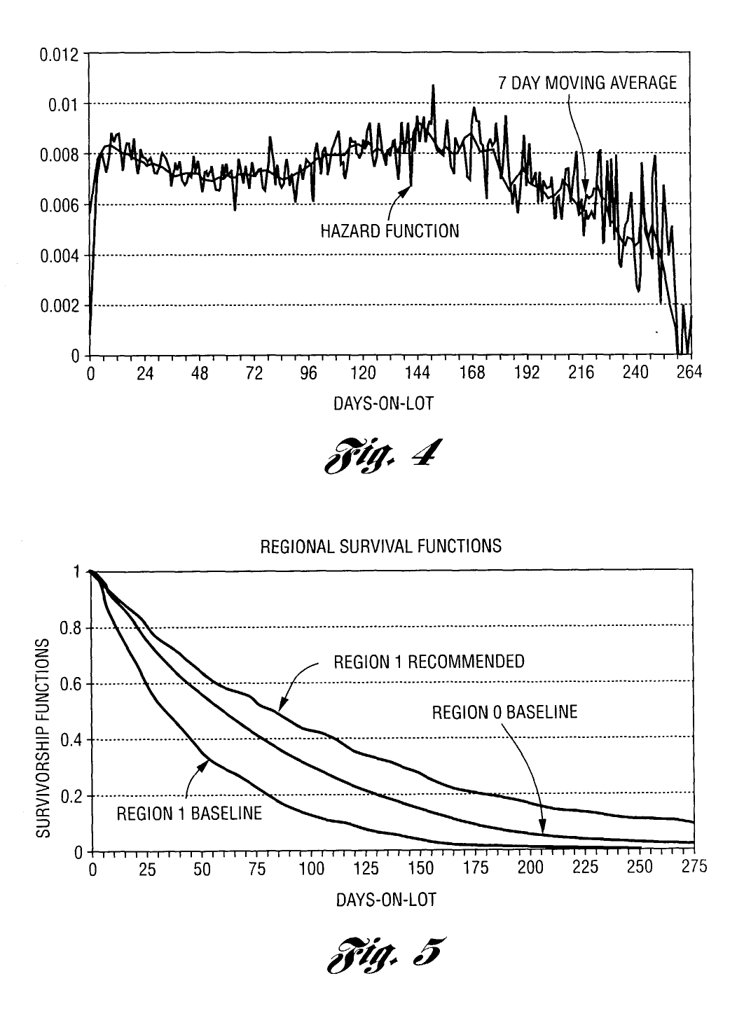

Referring to FIG. 4, another function one might consider is the hazard rate function, also referred to as the conditional failure rate. The hazard rate may be expected to increase slowly over time because of the cost to the dealerships associated with maintaining inventory. A discrete approximation to the instantaneous hazard rate (e.g., FIG. 4) rates might suggest the trend and characteristics of hazard dates over time. There are other national models one can use. There are other national models one can use such as one in which the regional effects are not used as co-variants.

F. Regional Models

The example estimation of unique survival functions for Regions 1 and 0 are particularly interesting to compare and contrast for Vehicle X. In the case of Region 0, there are a large number of vehicles (nearly 18% of the entire sample of 125,000 vehicles), of which nearly 93% come equipped with a 4×2 driveline. On the other hand, Region 1 is characterized by sales volumes for Vehicle X that are one-tenth of the volumes in Region 0, with almost the entire sample consisting of vehicles equipped with the 4×4 driveline. For these example analyses, the same definition of baseline vehicle is maintained as used for the national analysis except that the co-variants for encoding the different regions are deleted. Note that this choice of baseline corresponds to that configuration (including exterior paint color) which appears most frequently in Region 0. On the other hand, the baseline configuration is not represented by any of the observations for Region 1. In fact, only 4 vehicles out of more than 2000 observations were not equipped with either Body Style B or Body Style C in that region. The results of the analysis for the two regions are shown in Table 4.

TABLE 4
Regional Proportional Hazards
Model Results for Vehicle X Sales

| | Region 0 | | Region 1 | |
|---|---|---|---|---|
| | PAR. | | PAR. | |
| CO-VARIATE | VALUE | FREE | VALUE | FREE |
| Axle 2 | −0.335 | 0.022 | | 0.000 |
| Axle 3 | 0.180 | 0.392 | | 0.745 |
| Axle 4 | | 0.001 | | 0.191 |
| Axle 5 | | 0.006 | | 0.000 |
| Body Style B | | 0.022 | −1.083 | 0.552 |
| Body Style D | −0.529 | 0.409 | | 0.003 |
| Body Style C | | 0.049 | −1.190 | 0.444 |
| W/O CD Changer | −0.096 | 0.108 | | 0.237 |
| Engine 2 | −0.546 | 0.497 | −0.270 | 0.791 |
| Eng Blk Heater | | 0.000 | | 0.000 |
| Rear Ent Sys | 0.668 | 0.313 | | 0.038 |
| Heated Seats | | 0.038 | | 0.382 |
| Moon roof | 0.241 | 0.063 | | 0.528 |
| Rev Sensing | | 0.072 | | 0.200 |
| 2nd Row Capts | | 0.109 | | 0.101 |
| Skid Plate | | 0.047 | | 0.0455 |
| 4-Corner Load Level | −0.579 | 0.009 | −0.406 | 0.078 |
| Rear Load Level | −0.232 | 0.138 | | 0.000 |
| Tire 2 | 0.302 | 0.510 | | 0.003 |
| Trailer Tow | | 0.203 | | 0.799 |
| Trim Color 3 | | 0.085 | −0.226 | 0.179 |
| Trim Color 3 | | 0.188 | | 0.326 |
| Trim Type 2 | −0.222 | 0.611 | | 0.690 |
| Trim Type 3 | | 0.029 | | 0.040 |
| Trim Type 4 | −0.203 | 0.061 | | 0.144 |
| W/O Comf/Conv Group | −0.320 | 0.024 | −0.453 | 0.020 |
| Off-Road Package | 0.325 | 0.030 | | 0.029 |
| Sport App Pkg | −0.420 | 0.084 | | 0.329 |
| Exterior Paint 2 | | 0.152 | 0.481 | 0.261 |
| Exterior Paint 3 | −0.211 | 0.029 | | 0.038 |
| Exterior Paint 4 | −0.182 | 0.081 | | 0.063 |
| Exterior Paint 5 | | 0.020 | | 0.009 |
| Exterior Paint 6 | −0.214 | 0.122 | | 0.123 |
| Exterior Paint 7 | −0.207 | 0.097 | | 0.101 |
| Exterior Paint 8 | −0.085 | 0.124 | 0.247 | 0.107 |
| Exterior Paint 9 | −0.328 | 0.197 | | 0.131 |
| Exterior Paint 10 | −0.198 | 0.069 | 0.198 | 0.126 |

A number of similarities are noted as well as differences between the two regional models and the national model described earlier. In all cases, Engine 2 tends to slow down the sales rate. It is also noted that those vehicles that appear without the Comfort/Convenience Group, although relatively small in terms of frequency of occurrence, sell at a slower rate than do those vehicles with the Comfort/Convenience Group. One conclusion might be that all vehicles in these two regions should come equipped with this option. Relatively slow sales rates were also observed for those vehicles equipped with the 4-Corner Load Leveling Suspension, which suggests that this option should not be ordered for these two regions. There are also notable differences in the days-on-lot impact of different exterior paint colors. In Region 0, Exterior Paints 2 and 5 sell relatively quickly, while Exterior Paints 2, 8 and 10 perform best in Region 1.

Of particular significance are the parameter values associated with the two 4×4 vehicles for Region 1, which are both approximately −1.1 for the regional analysis. These values imply that Body Style B and Body Style C vehicles sell at one-third of the rate of the baseline vehicle. Thus, the baseline survival function should drop off much faster than that of a similar vehicle with Body Style B or Body Style C for Region 1. However, the baseline vehicle configuration is not representative of the types of vehicles that are sold in Region 1. Thus, we define an alternative vehicle for Region 1 on the basis of the frequency of occurrence of vehicle features and options. In this case, we select a vehicle with Body Style B, Engine 2 and Exterior Color 2 as the only differences from the baseline vehicle. The resulting survival curve indicates a substantially slower sales rate than that of the baseline vehicle in Region 1. These results are illustrated in FIG. 5.

### Estimation of Average Days-On-Lot

From the survival analysis, the parameter estimates are obtained for all co-variants and baseline survival function. Because many vehicles were not sold at the time the example data was collected, the survival function S(t) is not zero at the largest observed days-on-lot t_{D}. To calculate the average days-on-lot, the tail distribution of the survival function may be estimated. One might consider non-parametric techniques for estimation beyond t_{D}: First, set S(t)=0 for all t>t_{D}; Another technique corresponds to assuming the last censored individual(s) fail at infinity. These two extreme treatments may not be suitable in the present example. For current model year, one cannot assume vehicles are all sold within the last observed days-on-lot (in our case 263) and we cannot assume some vehicles stay on the lot forever. The tail can be completed by an exponential curve picked to give the same value of S(t_{D}). The estimated survival function for t>t_{D} is given by

$$\hat{S} ( t ) = exp \{ \frac{t ln [ \hat{S} ( {t}_{D} ) ]}{{t}_{D}} \} \qquad ( 18 )$$

Other methods could be utilized as well. For example, if one assumes all vehicles are sold within, say, 700 days after it arrives at the dealer lot, we can set Ŝ(700)=0, and connect a smooth decreasing curve between (t_{D},S(t_{D})) and (700,0). Different assumptions of the tail distributions will give different numbers of average days-on-lot. But the basic conclusions about which vehicle options affect days-on-lot and how they affect days-on-lot should remain the same.

From the baseline survival function Ŝ₀(t), the average days-on-lot may be expressed as:

$$\begin{matrix}{μ}_{0} = {\int }_{0}^{∞} {\hat{S}}_{o} ( t ) ⅆ t = {\sum }_{i = 1}^{D} {\hat{S}}_{0} ( {t}_{i} ) ( {t}_{i} - {t}_{i - 1} ) + {\int }_{{t}_{D}}^{∞} {\hat{S}}_{0} ( t ) ⅆ t \\ where & ( 19 ) \\ {\hat{S}}_{0} ( t ) = exp \{ \frac{t ln [ {\hat{S}}_{0} ( {t}_{D} ) ]}{{t}_{D}} \} & ( 20 )\end{matrix}$$

For vehicles with co-variate Z,Ŝ(t,Z)=Ŝ₀(t)^{exp(β}^{^{T}}^{Z)}, the average days-on-lot may be calculated similarly.

The above example was performed by region for Vehicle X. There were 17 sales regions. There was a baseline survival function for each region for calculating the average days-on-lot for the baseline vehicles and vehicles with various co-variants. A typical result is in Table 5.

TABLE 5
Vehicle X Recommendations by Region
Region 13
Average Days-on-lot = 158 through May 18, 2001
Vehicle X Recommendations
Base Vehicle (expected days-on-lot-155 )

Body Style B
Axle 3
With CD Changer
Engine 2
Exterior Paint 9
Trailer Tow
Trim Type 2
Comfort Group
Skid Plate

Features That Improve Sales Rate:

| | |
|---|---|
| Without CD Changer | 7% decrease in DOL |
| Add Rear Ent. Sys | 22% |
| Heated Seats | 6% |
| Add Moon roof | 14% |
| Off-Road Package | 19% |
| Exterior Paints 2 and 8 | 15% |

Features That Decrease Sales Rate:

| | |
|---|---|
| Engine 2 | 14% increase in Dol 2nd Row |
| Captain's Chairs | 11% |
| Rear Load Level | 11% |
| Trailer Tow Pkg. | 12% |
| Exterior Paints 3, 4, 6, 9 | increase DOL |

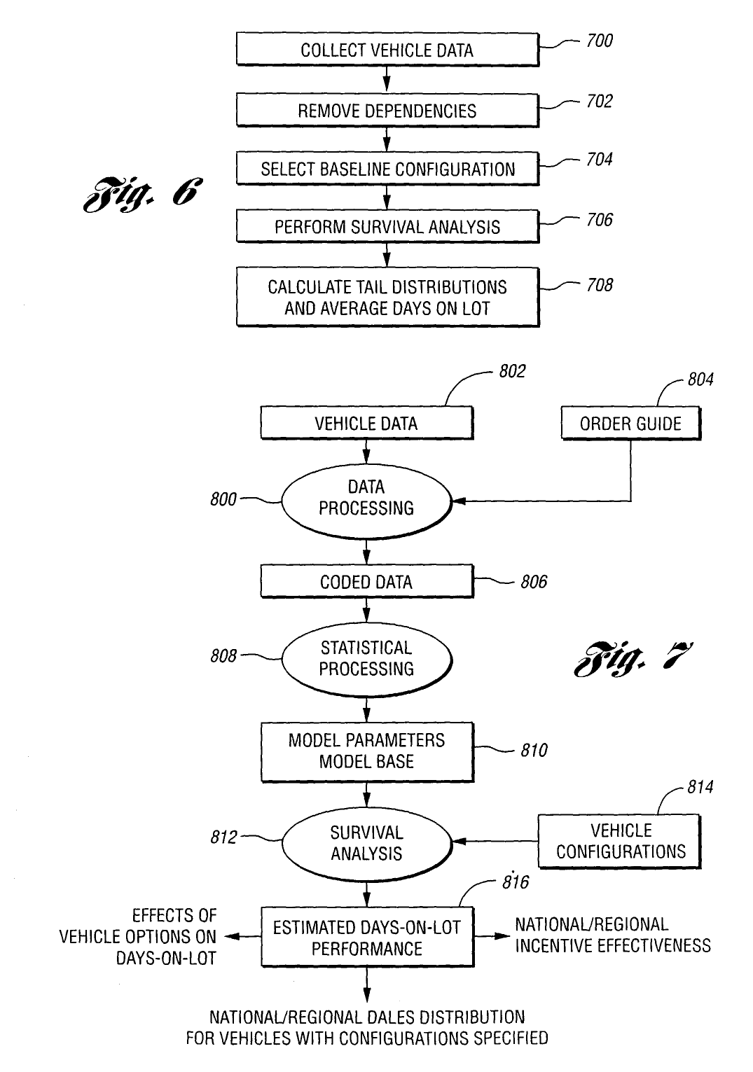

FIG. 6 is a block flow diagram illustrating a preferred methodology for implementing the present invention. Notably, the content and arrangement of one or more steps illustrated in FIG. 6 may be adapted, eliminated or rearranged within the scope of the present invention to best fit a particular implementation scenario.

One step in the preferred methodology is data collection, as represented in block 700. This step involves obtaining relevant data for one or more automobile model year(s), brand(s), series, etc. Relevant data types are described in greater detail above.

Another step in the preferred methodology involves identifying dependencies among vehicle options, as represented in block 702. This step may be implemented with a statistical procedure. Preferably, redundant vehicle options/features are deleted.

If the order guide can be rearranged in a way such that a computer can detect relations among different co-variates, such an operation may be included in the methodology.

The next step in the preferred methodology involves selecting a baseline vehicle configuration as represented in block 704. This configuration will typically be that having the largest number of observations. This step could be performed on a national or regional level if desired.

Another step in the methodology involves performing a survival analysis on the vehicle data as represented in block 706. This survival analysis can be implemented with commercially available software such as SAS® LIFETEST and PHREG (www.sas.com). The SAS LIFETEST procedure computes non-parametric estimates of the survival distribution and rank tests for the association of the event time (i.e., days-on-lot) variable with other variables. Both product-limit and life table estimates of the distribution are available. The SAS PHREG procedure may perform a regression analysis of survival data based on the Cox proportional hazards model. In Proc PHREG, the syntax may be similar to that of the other regression procedures in the SAS system. One example is to use a backward stepwise regression with significance value 0.15. For all covariates in the model, the one with the largest p-value may be removed if the p-value exceeds 0.15. Then, the regression may be done with the remaining covariates resulting in a new set of p-values. This process can be repeated until all p-values are less than 0.15.

There are several ways to treat ties in PHREG. For example, Efron's method may be chosen in cases where there is a large data set with several ties. The output may include the set of β values, standard error, chi-square, significance level, risk ratio, etc. Table 6 contains a typical output for a stock vehicle. Table 7 contains parameter estimates for this data.

TABLE 6
Summary of the Number of Event and Censored Values

| Total | Event | Censored | Percent Censored |
|---|---|---|---|
| 120804 | 73840 | 46964 | 38.88 |

TABLE 7
National Model Maximal Likelihood Parameter Estimates

| | | Parameter | Standard | Wald | | Risk |
|---|---|---|---|---|---|---|
| Variable | DF | Estimate | Error | X² | PrX² | Ratio |
| Axle 2 | 1 | −0.051941 | 0.01910 | 7.39351 | 0.0065 | 0.949 |
| Axle 3 | 1 | −0.093505 | 0.02508 | 13.89632 | 0.0002 | 0.911 |
| Axle 4 | 1 | −0.164092 | 0.02287 | 51.48456 | 0.0001 | 0.849 |
| Body Style B | 1 | −0.512966 | 0.02577 | 396.21785 | 0.0001 | 0.599 |
| Exterior | 1 | 0.127171 | 0.01264 | 101.16737 | 0.0001 | 1.136 |
| Color 2 | | | | | | |

The PHREG procedure may also include a statement called “baseline”. This feature may calculate the survival function with user-specified co-variants. This feature may also provide upper and lower confidence bands with user-specified confidence levels. When zeros are chosen for all co-variants, the baseline survival function results. Example output for the national model for Vehicle X is in Table 8. The confidence level for the upper, lower limit estimates of survival function is 95%.

TABLE 8
Baseline Vehicle Survival Function Estimate

| Co-variate Names | Time | S | S_Lower | S_Upper |
|---|---|---|---|---|
| Co-variate values-all equal | | 1 | | |
| to 0 for baseline | | | | |
| | 0 | 0.994298 | 0.993753 | 0.994845 |
| | 1 | 0.985408 | 0.984507 | 0.98631 |
| | 2 | 0.97452 | 0.973287 | 0.975754 |
| | 263 | 0.027365 | 0.024746 | 0.030261 |

Residues may be used to investigate the lack of fit of a model to a given subject. PHREG can output the martingale and deviance residues.

Another step in the preferred methodology illustrated in FIG. 6 may include calculating tail distributions and average days-on-lot, as represented in block 708. During this step, slow-selling and desirable vehicle options may be identified, as described in greater detail above.

FIG. 7 illustrates an alternative methodology for implementing the present invention. Notably, the content and arrangement of one or more steps illustrated in FIG. 7 may be adapted, eliminated or rearranged within the scope of the present invention to best fit a particular implementation scenario.

In a data processing step 800, vehicle data 802 and order data 804 are received, processed and converted to coded data 806. In a statistical processing step 808, the coded data 806 is received and processed. Outputs of statistical processing step 808 include model parameters and a model base 810. A survival analysis 812 is performed based on the model parameters/model base 810 and vehicle configurations 814 to generate estimated days-on-lot performance metrics 816. Estimated days-on-lot performance 816 may be utilized to determine the effects of vehicle options on days-on-lot, the effectiveness of national/regional incentive programs, and the national/regional sales distribution for vehicles having the specified configurations.

While the best mode for carrying out the invention has been described in detail, those familiar with the art to which this invention relates will recognize various alternative designs and embodiments for practicing the invention as defined by the following claims.

What is claimed:

1. A method for calculating a probability that one ore more automobiles will be sold by a future date, the method comprising:
performing a survival analysis based on historical days-on-lot data for a group of automobiles to generate a survival function; and
calculating a probability that one or more automobiles will be sold by a future date based on the survival function.

2. The method of claim 1 wherein the days-on-lot data includes an indication as to whether automobiles have been sold.

3. The method of claim 1 wherein the days-on-lot data includes geographic information.

4. The method of claim 1 wherein the survival analysis additionally includes automobile content data.

5. The method of claim 4 additionally comprising:
identifying a baseline content configuration; and
calculating a sales impact value for one or more automobile content items wherein the sales impact value is relative to the baseline content configuration.

6. The method of claim 1 wherein the survival analysis additionally includes incentive or automobile pricing data.

7. The method of claim 6 wherein the incentive or automobile pricing data includes competitor incentive or automobile pricing data.

8. The method of claim 1 wherein the survival analysis additionally includes time-varying event data.

9. The method of claim 1 wherein the survival analysis additionally includes marketing data.

10. The method of claim 1 additionally comprising:
encoding data to be input to the survival analysis into co-variate data; and
performing the survival analysis on the co-variate data.

11. The method of claim 1 additionally comprising calculating a tail distribution for the survival function.

12. The method of claim 1 wherein co-dependent data is excluded from the survival analysis.

13. A method for estimating vehicle days-on-lot performance, the method comprising:
in a data processing step, converting vehicle data into coded data;
in a statistical processing step, generating model parameters and a model based on the coded data; and
in a survival analysis step, estimating vehicle days-on-lot performance.

14. The method of claim 13 additionally comprising estimating the effectiveness of a vehicle incentive program based on the survival analysis.

15. The method of claim 13 additionally comprising defining a sales distribution based on the survival analysis.
